(19) United States
(12) Patent Application Publication
(10) Pub. No.: US 2026/0024965 A1
(43) Pub. Date: Jan. 22, 2026

(54) INSULATION BARRIER FOR SWITCHGEAR ASSEMBLY AND METHOD FOR ASSEMBLING A SWITCHGEAR

(71) Applicant: Siemens Industry, Inc., Alpharetta, GA (US)

(72) Inventors: Aaron Isaac Blankenship, Keller, TX (US); Jason Parkerson, Mansfield, TX (US)

(73) Assignee: Siemens Industry, Inc., Alpharetta, GA (US)

(21) Appl. No.: 19/237,397

(22) Filed: Jun. 13, 2025

Related U.S. Application Data
(60) Provisional application No. 63/672,913, filed on Jul. 18, 2024.

(51) Int. Cl. H02B 13/02

(52) U.S. Cl. CPC H02B 13/02

(57) ABSTRACT

A switchgear assembly and a method for assembling a switchgear are disclosed. A switchgear assembly includes a cabinet structure with a support post assembly, the cabinet structure housing electrical components including lugs and lug pads for connecting electrical cables, an insulation barrier secured to the support post assembly, wherein the insulation barrier covers the electrical components including the lugs and lug pads to provide protection, and wherein the insulation barrier comprises one or more flexible openings allowing the electrical cables to pass through the insulation barrier. Further, a method for assembling switchgear includes connecting electrical cables to lugs and lug pads within a cabinet structure of a switchgear device, installing an insulation barrier after the connecting of the electrical cables such that the insulation barrier covers electrical components including the lugs and lug pads to provide protection, wherein the insulation barrier comprises one or more flexible openings allowing the electrical cables to pass through the insulation barrier.

### TECHNICAL FIELD

Aspects of the present disclosure generally relate to switchgear for electrical power distribution, and more specifically to a switchgear assembly including an insulation barrier.

### BACKGROUND ART

Switchgear, switchboards, panel boards and other assemblies are general terms which cover metal enclosures or cabinets that house switching and interrupting devices such as fuses and circuit breakers along with associated control, instrumentation and metering devices. Such assemblies typically include buses, interconnections and supporting structures used for distribution of electric power. In addition, the assemblies are categorized as high, medium and low voltage switchgear and switchboards. Low voltage switchgear and switchboards operate at voltages up to 1000 volts and with continuous currents up to 6000 amperes. They are designed to withstand short-circuit currents up to 200,000 amperes.

Typical switchgear equipment includes a lineup of multiple metal enclosed sections. Each section may have several circuit breakers stacked one above the other vertically in the front of the section with each breaker being enclosed in its own metal compartment. Each section has a vertical or section bus which supplies current to the breakers within the section via short horizontal branch buses, also referred to as run-in buses, which extend through insulated openings in the rear wall of the breaker compartments. The vertical buses in each section are supplied with current by a horizontal main bus that runs through the line-up. The rear of the section is typically an open area for routing electrical cables.

Switchgear insulation refers to materials and techniques used to isolate energized electrical components within a switchgear enclosure, preventing electrical faults and protecting personnel from electrical shock. An example of switchgear insulation is InsulBoot®, a plastic switchgear and bus bar boots for insulating bus bar and switchgear connections. These insulating boots are flexible “enclosures” that shroud exposed cable lugs and lug pads. However, these boots are cumbersome to install and can be expensive.

### SUMMARY

A switchgear assembly and a method for assembling switchgear are described. More specifically, the present disclosure relates to the use of an insulation barrier to protect an operator from accidentally contacting live (energized) buses, lugs and other electrical parts of a switchgear assembly. The insulation barrier specifically addresses cable connections.

Exemplary embodiments are described in the context of switchgear and switchgear assemblies, in particular low voltage switchgear. However, it should be noted that the switchgear and switchgear assemblies described herein may be designed as switchboards, medium voltage switchgear and/or motor control centers.

A first aspect of the present disclosure provides a switchgear assembly comprising a cabinet structure comprising a support post assembly, the cabinet structure housing electrical components including lugs and lug pads for connecting electrical cables, an insulation barrier secured to the support post assembly, wherein the insulation barrier covers the electrical components including the lugs and lug pads to provide protection, and wherein the insulation barrier comprises one or more flexible openings allowing the electrical cables to pass through the insulation barrier.

A second aspect of the present disclosure provides a method for assembling a switchgear, the method comprising connecting electrical cables to lugs and lug pads within a cabinet structure of a switchgear device, installing an insulation barrier after the connecting of the electrical cables such that the insulation barrier covers electrical components including the lugs and lug pads to provide protection, wherein the insulation barrier comprises one or more flexible openings allowing the electrical cables to pass through the insulation barrier.

### BRIEF DESCRIPTION OF THE DRAWINGS

FIG. 1 illustrates a perspective view of a switchgear assembly with a first example of an insulation barrier in accordance with exemplary embodiments of the present disclosure.

FIG. 2 illustrates a side view of the switchgear assembly with the first example of the insulation barrier in accordance with exemplary embodiments of the present disclosure.

FIG. 3 and FIG. 4 illustrate front views of variations of the first example of the insulation barrier in accordance with exemplary embodiments of the present disclosure.

FIG. 5 illustrates a perspective view of a switchgear assembly with a second example of an insulation barrier in accordance with an exemplary embodiment of the present disclosure.

FIG. 6 illustrates a side view of the switchgear assembly with the second example of the insulation barrier in accordance with an exemplary embodiment of the present disclosure.

FIG. 7 illustrates an exploded view of the second example of the insulation barrier in accordance with an exemplary embodiment of the present disclosure.

FIG. 8 illustrates perspective views of a switchgear assembly with a third example of an insulation barrier in accordance with an exemplary embodiment of the present disclosure.

FIG. 9 illustrates a front view of the third example of the insulation barrier in accordance with an exemplary embodiment of the present disclosure.

FIG. 10 and FIG. 11 illustrate front views of variations of the third example of the insulation barrier in accordance with an exemplary embodiment of the present disclosure.

FIG. 12 illustrates a flow chart for a method for assembling switchgear in accordance with exemplary embodiments of the present disclosure.

### DETAILED DESCRIPTION

To facilitate an understanding of embodiments, principles, and features of the present disclosure, they are explained hereinafter with reference to implementation in illustrative embodiments, wherein like reference numerals represent like elements throughout. They are described in the context of switchgear and switchgear assemblies, in particular low voltage switchgear. However, it should be noted that the switchgear and switchgear assemblies described herein may be designed as switchboards, medium voltage switchgear and/or motor control centers.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

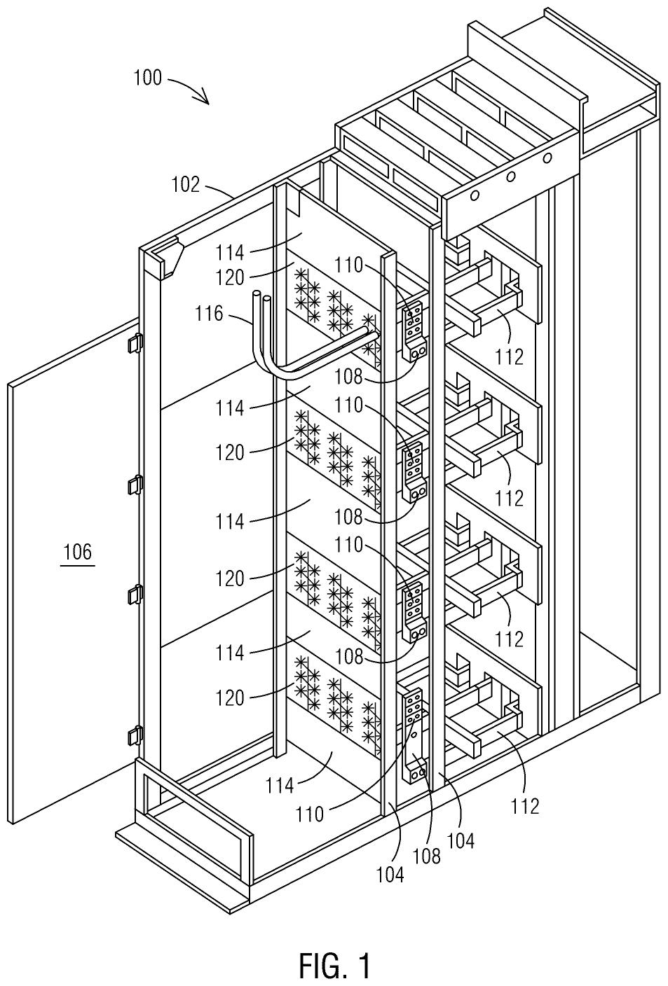

FIG. 1 illustrates a perspective view of a switchgear assembly 100 with a first embodiment of an insulation barrier 120 in accordance with exemplary embodiments of the present disclosure.

In an example, the switchgear assembly 100 is configured as a low voltage switchgear assembly having a continuous current rating of up to 6000 amperes. The switchgear assembly 100 includes a cabinet structure 102 having side walls fabricated, for example, from sheet metal. Most of the side walls are removed to reveal components of the switchgear assembly 100.

The switchgear assembly comprises a cabinet structure 102 with a support post assembly 104. In general, the cabinet structure 102 includes compartments with different components, such as circuit breaker compartments and other compartments. The circuit breaker compartments house a circuit breaker suitable for low voltage switchgear and include a compartment front panel. The other compartments may house electronic components for use in the switchgear assembly. Access to the different compartments is provided by cabinet doors.

Electrical components including lugs 110 and lug pads 108 are housed in cable compartments of the cabinet structure 102. Electrical cables 116 are operably coupled to the lugs 110 and lug pads 108, wherein the lug pads 108 are coupled to runback bases 112. The runback bases 112 refer to horizontal busbars that extend from a load side of each circuit breaker connecting to the cable compartments. The runback bases 112 provide lug landings for terminating load cables 116 without directly connecting to a main bus. They are essentially a dedicated pathway for power to reach the load cables 116. The electrical cables 116 transmit electric power, more specifically electric current.

Switchgear insulation is used to isolate energized electrical components within a switchgear enclosure, preventing electrical faults and protecting personnel from electrical shock. It is crucial to prevent accidental contact with energized components, such as the lugs, lug pads and busbars, especially when personnel are working in the cable compartment area of the switchgear assembly 100.

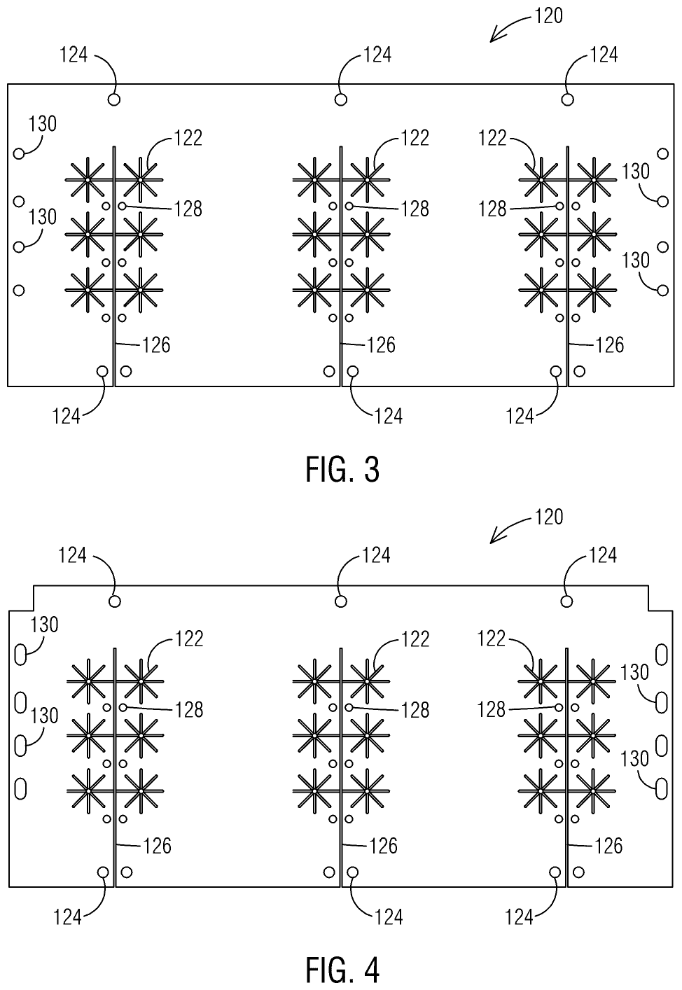

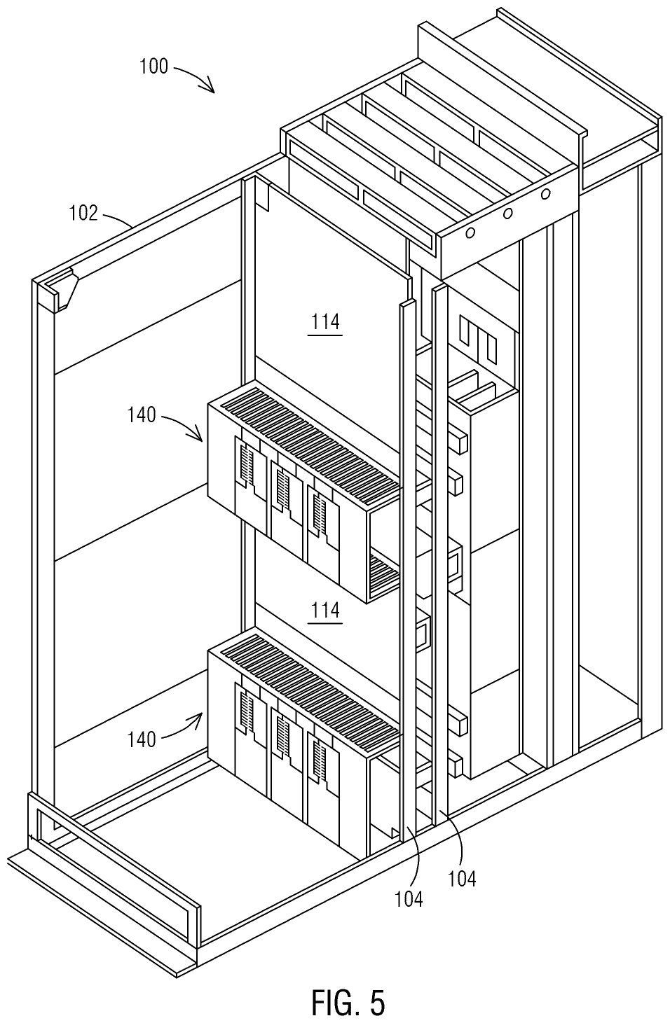

In an exemplary embodiment of the present disclosure, an insulation barrier 120 is provided and secured to the support post assembly 104. The insulation barrier 120 covers the electrical components including the lugs 110, lug pads 108 and runback bases 112 to provide protection from these components when they are energized. The insulation barrier 120 comprises one or more flexible openings allowing the electrical cables 116 to comfortably pass through the insulation barrier 120. The insulation barrier 120 will be described in more detail with reference to FIG. 3 and FIG. 4.

In the example of the switchgear assembly 100 as illustrated in FIG. 1, the switchgear assembly 100 comprises a plurality of insulation barriers 120, since the assembly 100 comprises a plurality of cable compartments. In general, the number of insulation barriers 120 corresponds to the number of cable compartments. Further, the assembly 100 comprises bus compartment barriers 114, which are also secured to the support post assembly 104. In our example, the bus compartment barriers 114 and insulation barriers 120 are arranged alternately. However, it should be noted that the insulation barrier(s) 120 and other barriers may be arranged differently. Rear door 106 provides access to a rear of the switchgear assembly 100.

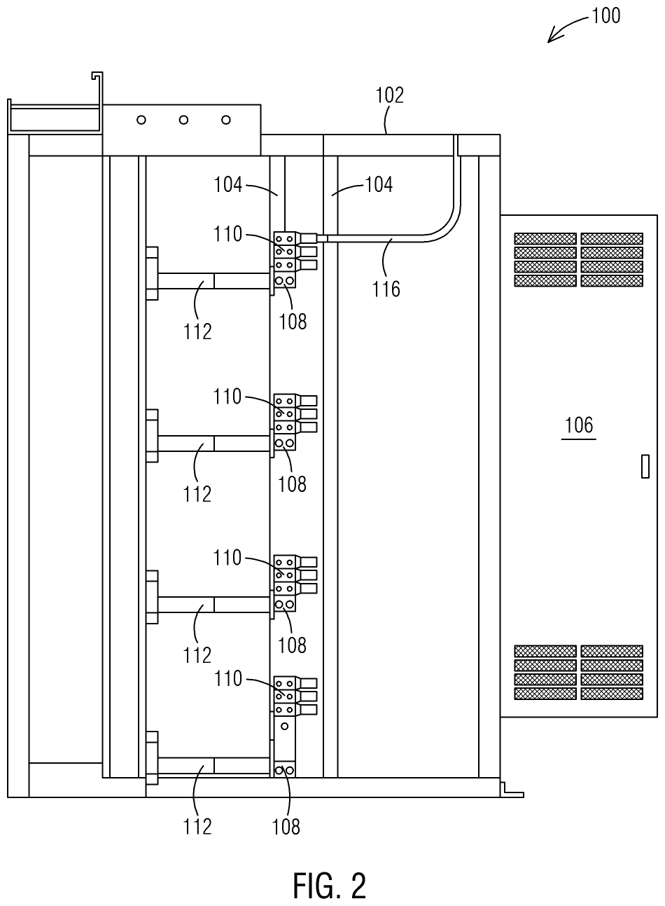

FIG. 2 illustrates a side view of the switchgear assembly 100 with the first insulation barrier 120 in accordance with exemplary embodiments of the present disclosure.

The support post assembly 104 comprises multiple posts which can be installed in multiple locations within the cabinet structure 102, depending on different circumstances or requirements. For example, the support post assembly 104 can be installed in multiple locations depending on the size of the lugs 110, and to ensure that the insulation barrier(s) 120 and bus compartment barriers 114 (not visible in FIG. 2) are set away from the end of the lugs 110. The support post assembly 104 includes individual L-shaped posts, to provide different mounting surfaces.

Further illustrated are the lug pads 108, runback bases 112 and the rear door 106. The electrical cables 116 are connected to the lugs 110. While FIG. 1 and FIG. 2 shows that cables 116 exit the switchgear assembly 100 at a top portion, it should be noted that the electric cables 116 may exit the switchgear assembly 100 at a different side or portion, such as a bottom portion or side portion.

FIG. 3 and FIG. 4 illustrate front views of variations of the first embodiment of the insulation barrier 120 in accordance with exemplary embodiments of the present disclosure.

The insulation barrier 120 is designed as a type of shield or cover, made from non-conductive materials (insulators) that resist the flow of electrical current. Examples include synthetic materials such as plastics and rubber. In an embodiment, the insulation barrier 120 is designed and manufactured as one single element, wherein all phases of the electrical system are protected with the same single insulation barrier.

The insulation barrier 120 comprises a plurality of slit cutouts, for example star-shaped slit cutouts 122. Other slit cutout shapes are conceivable. The number of star-shaped slit cutouts 122 corresponds to the number of cables 116 that can be connected to the switchgear 100. In our example, six (6) cables per phase can be connected, which is a total of 18 individual cables 116. Thus, the insulation barrier 120 comprises 18 star-shaped slit cutouts 122. The insulation barrier 120 further comprises holes 130 for mounting the insulation barrier 120 to the support post assembly 104 and holes 124 for mounting to the bus compartment barriers 114.

The insulation barrier 120 further comprise slits 126 for inserting the electrical cables 116. The slit cutouts 122 and slits 126 are aligned with a pathway of the electrical cables 116. Further, the insulation barrier 120 comprises holes 128 for inserting fastening elements, such as zip-ties, to hold the insulation barrier 120 in place after it has been installed.

With respect to an installation of the insulation barrier 120, it is designed so that it can be easily installed after all the electrical cables 116 are in place. Referring to FIG. 1, after the electrical cables 116 are operably connected to the lugs 110 and lug pads 108, the bus compartment barriers 114 are installed. Next, the insulation barrier(s) 120 are installed, wherein the slits 126 and slit cutouts 122 are aligned with a pathway of the cables 116 (the electrical cables 116 are insulated). Basically, the insulation barrier 120 is pushed or moved over the electric cables 116 in a vertical manner (for example from top to bottom), utilizing the slits 126 and slit cutouts 122.

After installing the insulation barrier 120, the star-shaped slit cutouts 122 deform around the electrical cables 116 and prevent an operator from touching the lugs 110 which are live electrical components. Thus, the non-conductive material used for the barrier 120 has some degree of flexibility so that the barrier 120 can be easily installed. Finally, the insulation barrier 120 is mounted to the support post assembly 104 and the bus compartment barriers 114, using for example self-tapping mounting screws. The mounting screws and fastening elements, e.g., zip-ties, in holes 128 hold the barrier 120 in place.

A difference between the variations of the insulation barrier 120 in FIG. 3 and FIG. 4 is a shape of the holes 130 for mounting the insulation barrier 120 to the support post assembly 104. The mounting holes 130 in FIG. 3 are circular in shape, wherein the mounting holes 130 in the example of FIG. 4 are oval in shape. Further, the insulation barrier 120 in the example of FIG. 4 comprises rectangular cutouts at top corners.

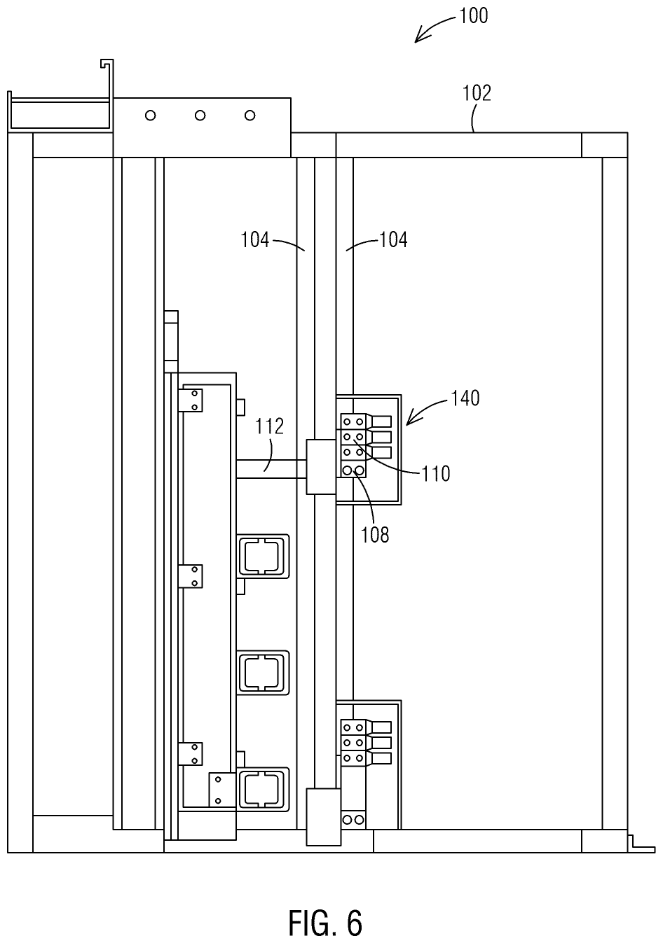

FIG. 5 illustrates a perspective view of a switchgear assembly 100 with a second embodiment of an insulation barrier 140 in accordance with an exemplary embodiment of the present disclosure.

In general, the switchgear assembly 100 corresponds to the switchgear assembly described with reference to FIG. 1 and comprises the cabinet structure 102 with support post assembly 104 including multiple L-shaped posts mounted to the cabinet structure 102. The one or more insulation barrier(s) 140 are mounted to the support post assembly and the bus compartment barriers 114 that are arranged in between the insulation barrier(s) 140.

In accordance with an exemplary embodiment of the present disclosure, the insulation barrier 140 comprises a plurality of elements which, when assembled and mounted, form the insulation barrier 140. Further, the insulation barrier 140 comprises individual sections for each phase of the electrical system, so that the insulation barrier 140 can be installed separately for each phase, for example for each single phase of a 3-phase electrical system. In contrast, the first embodiment of the insulation barrier 120 is designed and manufactured as one single element, wherein all phases of the electrical system are protected with the same single insulation barrier.

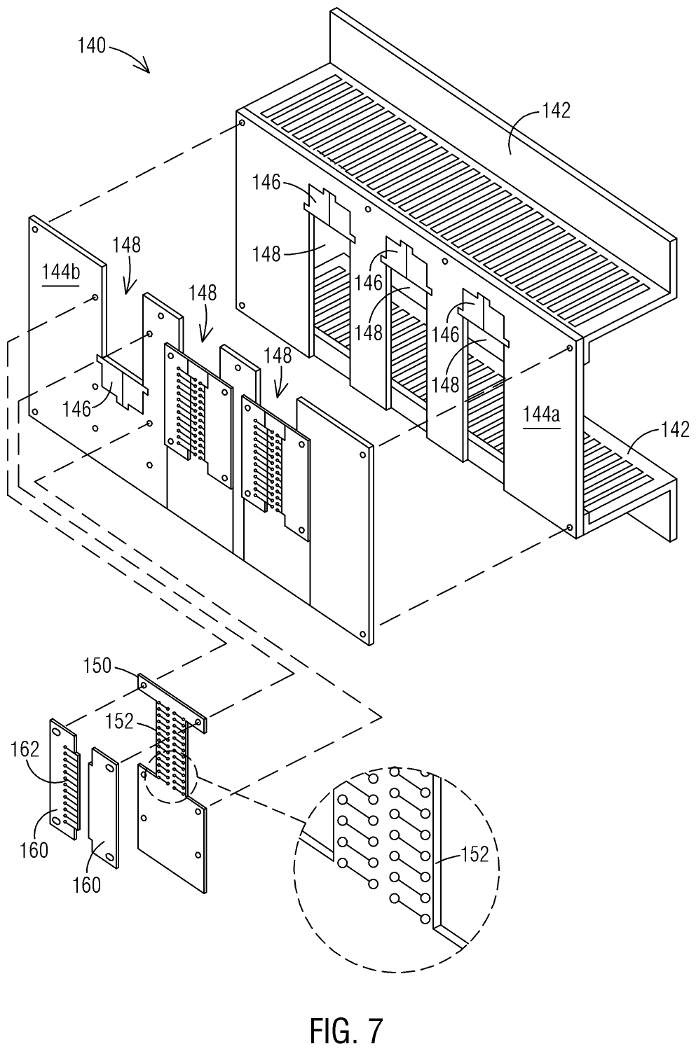

FIG. 6 illustrates a side view of the switchgear assembly 100 with the second embodiment of the insulation barrier 140 in accordance with an exemplary embodiment of the present disclosure.

The side view shows the lugs 110, lug pads 108 and runback bases (bus bars) 112, which are covered and protected by the insulation barrier 140. The insulation barriers 140 are set away from the lugs 110 and lug pads 108 to provide sufficient protection for operators. More specifically, the insulation barriers 140 protrude from the respective post of the support post assembly 104 to where the insulation barrier 140 is mounted to. The bus compartment barriers 114 (not visible in FIG. 6, see FIG. 5) do not protrude and are aligned (plane) with the respective post of the support post assembly 114.

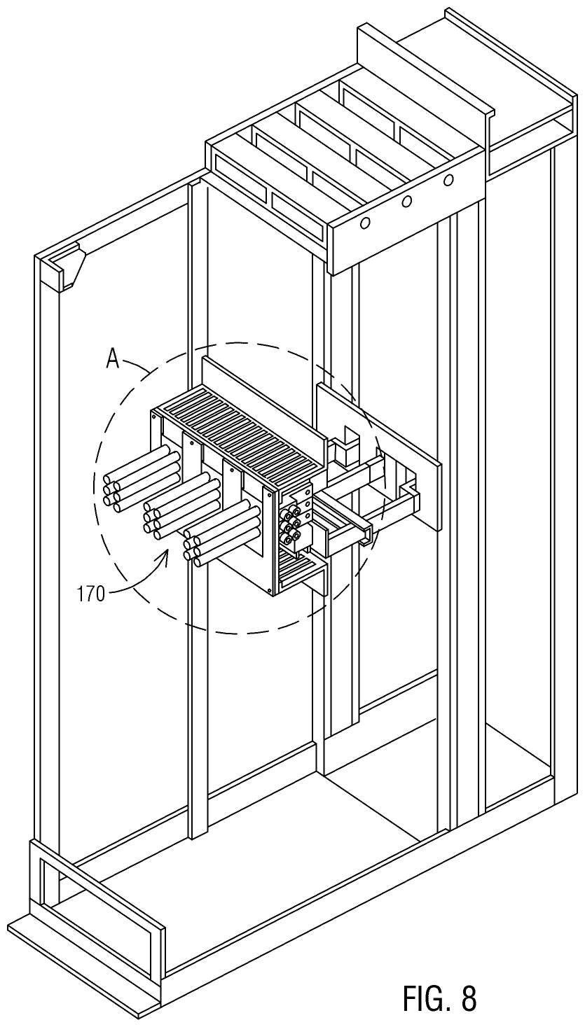

FIG. 7 illustrates an exploded view of the second embodiment of the insulation barrier 140 in accordance with an exemplary embodiment of the present disclosure.

In accordance with an exemplary embodiment of the present disclosure, the insulation barrier 140 comprises a plurality of elements including insulation brackets, mounting plates, inner barriers and outer barriers.

The insulation brackets 142 are secured to the support post assembly 104 by fastening means. The mounting plates 144 are secured to the insulation brackets 142 by fastening means. Both insulation brackets 142 and mounting plates 144 can be fastened by self-tapping screws.

There is a pair of insulation brackets 142, i.e., two (2) brackets 142, and a pair of mounting plates 144, i.e., two (2) mounting plates 144a, 144b. The insulation brackets 142 are essentially installed horizontally, and the mounting plates 144 are essentially installed vertically, thereby creating space and distance away from the (energized) electrical components, e.g., lugs and lug pads. The insulation brackets 142 and mounting plates 144 form a rectangular protrusion, which is open at its sides.

The mounting plates 144a, 144b are arranged and mounted parallel to each other, wherein one mounting plate 144b is mounted on top of the other second mounting plate 144a. Each mounting plate 144a, 144b comprises cutouts 148, specifically one cutout 148 per electrical phase. In our example, each mounting plate 144a, 144b comprises three (3) cutouts 148. The cutouts 148 are open to one side, so that, in a way, the mounting plate 144 has a form of a comb. During installation of the mounting plates, the mounting plates 144a, 144b are arranged so that the cutouts 148 of each plate 144a, 144b overlap, but the openings of each cutout 148 are on opposite sides.

The mounting plates 144a, 144b comprise knockout holes 146 providing a rigid covering for unused cable spots. In case the cable spots are needed, one or more knockout holes 146 can be easily removed, thereby providing additional cable spots. Each mounting plate 144a, 144b comprises six (6) knockout holes 146, which in total results in twelve (12) knockout holes. It should be noted that there may be less or more knockout holes 146 than described.

The insulation brackets 142 may comprise aluminum material, which can be painted. The mounting plates 144a, 144b comprise non-conductive material, such as for example Glastic®. Glastic® is a brand name for a line of thermoset fiberglass-reinforced polyester composite materials, known for their strength, excellent electrical properties and dimensional stability.

The insulation barrier 140 further comprises inner barriers 150 and outer barriers 160. The inner barriers 150 and outer barriers 160 comprise non-conductive materials. The inner barriers 150 and outer barriers 160 are configured as single-phase barriers. This means that the inner and outer barriers 150, 160 can be installed separately for each phase of the 3-phase electrical system.

The inner barriers 150 are mounted to the mounting plates 144, specifically to mounting plate 144b, for example by self-tapping screws. The outer barriers 160 are mounted to the inner barriers 150, for example by self-tapping screws.

The inner barriers 150 and the outer barriers 160 comprises parallel slit cutouts. Each inner barrier 150 comprises two (2) sets of slit cutouts 152, and each outer barrier 160 comprises one (1) set of parallel slit cutouts 162. When assembled, the slit cutouts 152, 162 overlap and provide a fan barrier design that allows the electrical cables to pass through the barriers and fold back on the electrical cables. The embodiment of the insulation barrier 140 allows for the electrical cables to bend and still fit around the cables.

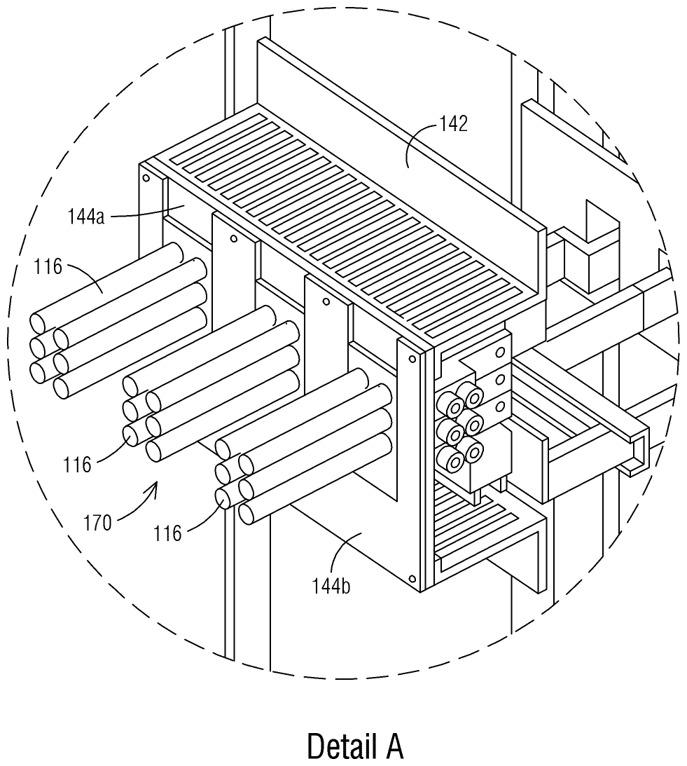

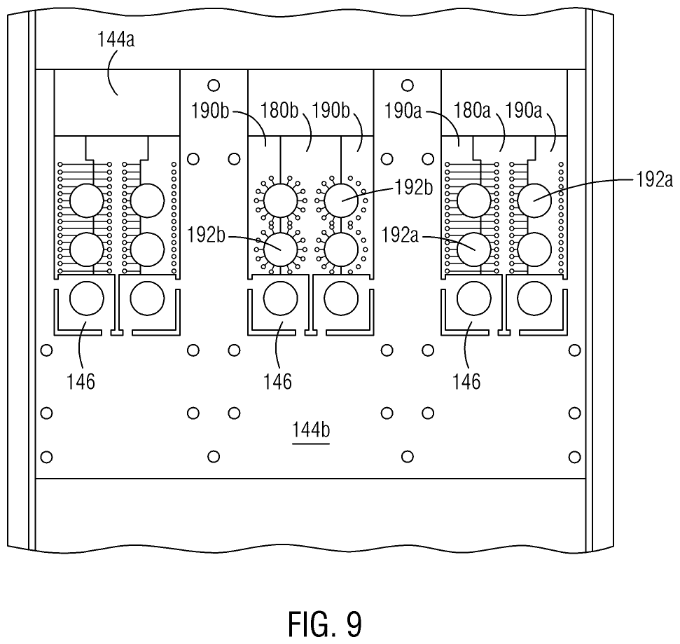

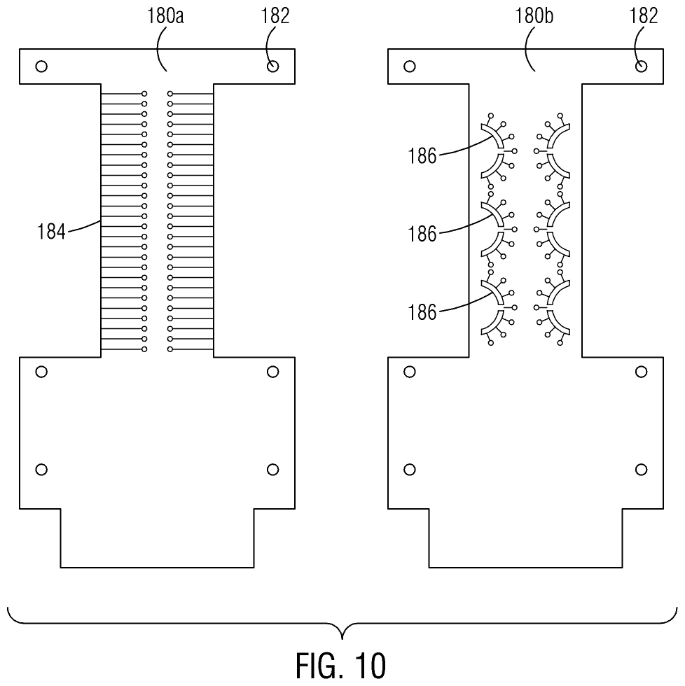

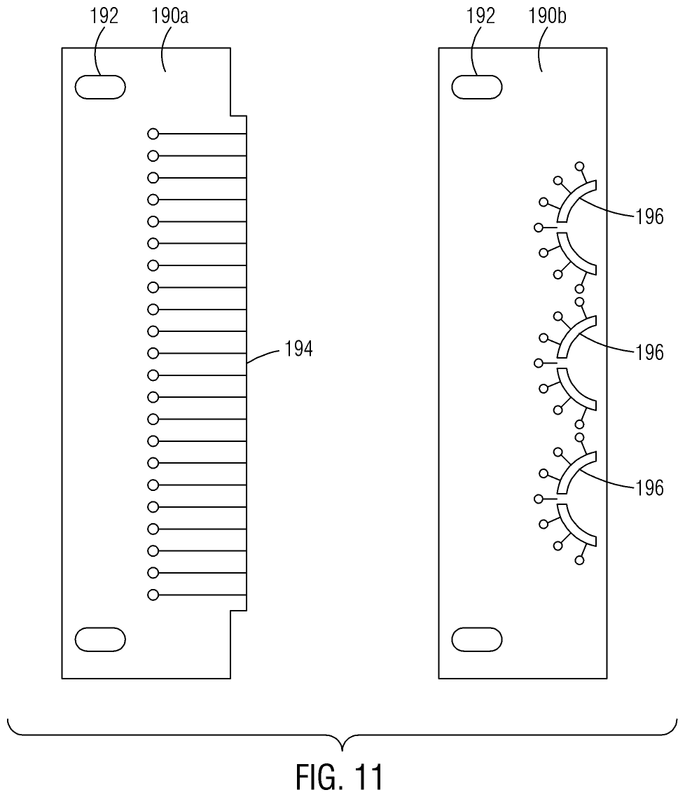

FIG. 8 along with Detail A illustrate a perspective view of a switchgear assembly with a third embodiment of an insulation barrier 170 in accordance with an exemplary embodiment of the present disclosure. FIG. 9, FIG. 10 and FIG. 11 show further details of the third embodiment of the insulation barrier 170. The switchgear assembly can be designed for example as previously described switchgear assembly 100, see for example FIG. 1 and FIG. 2.

With reference to FIG. 8 and Detail A, the insulation barrier 170 is similar to the embodiment of the insulation barrier 140. The insulation barrier 170 also comprises a plurality of elements including insulation brackets 142, mounting plates 144a, 144b, inner barriers and outer barriers. The insulation brackets 142 and mounting plates 144a, 144b correspond to the insulation brackets and mounting plates of the insulation barrier 140. In Detail A, the electrical cables 116 are shown and how they pass through the individual insulation barriers.

FIG. 9 illustrates a front view of the third embodiment of the insulation barrier 170 in accordance with an exemplary embodiment of the present disclosure.

The insulation barrier 170 also comprises a plurality of elements including insulation brackets 142, mounting plates 144a, 144b, inner barriers 180 and outer barriers 190. The mounting plates 144a, 144b comprise knockout holes 146. However, it should be noted that the mounting plates 144a, 144b may not comprise knockout holes 146 or may comprise less or more knockout holes 146 than illustrated.

Further, inner barriers 180 and outer barriers 190 are provided. The inner barriers 180 comprise different configurations 180a, 180b which align with different configurations of the outer barriers 190a, 190b. The outer barriers 190a align with the inner barrier 180a. The outer barriers 190b align with the inner barrier 180b. Each set of aligned inner barrier and outer barriers form flexible openings 192a, 192b for the electrical cables to pass through after the cables have been installed.

FIG. 10 and FIG. 11 illustrate front views of configurations of the inner barrier 180 and outer barrier 190 of the insulation barrier 170 in accordance with an exemplary embodiment of the present disclosure.

As illustrated, the inner barriers 180a and 180b may comprise different shapes and sizes of slit cutouts. The inner barrier 180a comprises parallel slit cutout, like inner barrier of insulation barrier 140. The inner barrier 180b comprises circular slit cutouts.

The inner barriers 180a, 180b and outer barriers 190a, 190b comprise non-conductive materials. The inner barriers 180a, 180b and outer barriers 190a, 190b are configured as single-phase barriers. This means that the inner and outer barriers can be installed separately for each phase of the 3-phase electrical system.

The inner barriers 180a, 180b are mounted to the mounting plates 144, specifically to mounting plate 144b, for example by self-tapping screws. The outer barriers 190a, 190b are mounted to the inner barriers 180a, 180b, for example by self-tapping screws. More specifically, outer barriers 190a are mounted to inner barriers 180a, and outer barriers 190b are mounted to inner barriers 180b.

The inner barriers 180a and the outer barriers 190s comprise parallel slit cutouts. Each inner barrier 180a comprises two (2) sets of slit cutouts 184, and each outer barrier 190a comprises one (1) set of parallel slit cutouts 194. When assembled, the slit cutouts 184, 194 overlap and provide a fan barrier design that allows the electrical cables to pass through the barriers and fold back on the electrical cables. The embodiment of the insulation barrier with barriers 180a, 190aallows for the electrical cables to bend and still fit around the cables.

The inner barriers 180b and the outer barriers 190b comprise slit cutouts that are arranged in a circular manner. Each inner barrier 180b comprises three (3) sets of semicircular slit cutouts 186, wherein each set includes two (2) semicircular slit cutouts 186. Each outer barrier 190b comprises three (3) sets of semicircular slit cutouts 196. For assembly, two (2) outer barriers 190b are adjacent to one outer barrier 180b. When assembled, the slit cutouts 186, 196 provide a circular flexible opening that allows the electrical cables to pass through the barriers and fold back on the electrical cables. The embodiment of the insulation barrier with barriers 180b, 190b allows for the electrical cables to bend and still fit around the cables.

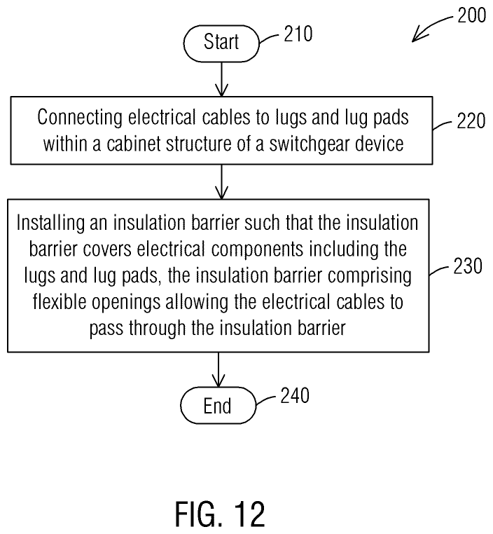

FIG. 12 illustrates a flow chart for a method 200 for assembling switchgear in accordance with exemplary embodiments of the present disclosure.

While the method 200 is described herein as a series of acts that are performed in a sequence, it is to be understood that the method may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The method 200 is described in connection with switchgear assemblies as described herein. More specifically, the method 200 is described in connection with the switchgear assembly 100 and different insulation barriers 120, 140 and 170 as described herein.

The method 200 may start at 210 and comprises act 220 of connecting electrical cables 116 to lugs 110 and lug pads 108 within a cabinet structure 102 of a switchgear device 100. In act 230, after the connection of the electrical cables 116, an insulation barrier 120, 140, 170 is installed such that the insulation barrier 120, 140, 170 covers electrical components including the lugs 110 and lug pads 108 to provide protection. The insulation barrier 120, 140, 170 comprises one or more flexible openings allowing the electrical cables 116 to pass through the insulation barrier 120, 140, 170. The method 200 may end at 240.

In an embodiment of the present disclosure, the installation of the insulation barrier 120, 140, 170 comprises passing the electrical cables 116 through the one or more flexible openings and mounting the insulation barrier to a support post assembly 104 of the cabinet structure 102.

In another embodiment of the present disclosure, the installation of the insulation barrier 120, 140, 170 comprises securing insulation brackets 142 to the support post assembly 104 in an essentially horizontally manner, securing mounting plates 144a, 144b to the insulation brackets 142 in an essentially vertical manner, wherein the insulation brackets 142 and mounting plates 144a, 144b, when installed, create space for distance to the electrical components including the lugs 110 and lug pads 108. In another embodiment of the present disclosure, the installation of the insulation barrier 120, 140, 170 further comprises securing inner barriers 150, 180a, 180b to the mounting plates 144a, 144b and securing outer barriers 160, 190a, 190b to the inner barriers 150, 180a, 180b.

The described switchgear assemblies 100 and method 200 for assembling a switchgear 100 provide different types of insulation barriers 120, 140 and 170, which prevent accidental contact with live (energized) electrical components such as bus, lugs, and other parts. The insulation barriers comprise flexible openings that support different sizes and shapes of electrical cables. The material(s) being used for the insulation barriers is cost effective. Multiple designs can be made using the same slit cutout method to accommodate any number of lugs (size or shape) and/or electrical cables. Further, the installation time of the insulation barriers is significantly reduced compared to known insulation methods.

1. A switchgear assembly comprising:
a cabinet structure comprising a support post assembly, the cabinet structure housing electrical components including lugs and lug pads for connecting electrical cables,
an insulation barrier secured to the support post assembly,
wherein the insulation barrier covers the electrical components including the lugs and lug pads to provide protection,
wherein the insulation barrier comprises one or more flexible openings allowing the electrical cables to pass through the insulation barrier.

2. The switchgear assembly of claim 1,
wherein the insulation barrier is configured to be installed after the electrical cables are operable connected to the lugs and lug pads.

3. The switchgear assembly of claim 1,
wherein the flexible openings support different sizes and shapes of the electrical cables.

4. The switchgear assembly of claim 1,
wherein the insulation barrier comprises non-conductive material and provides protection when the electrical components are energized.

5. The switchgear assembly of claim 1,
wherein the insulation barrier is a single component and configured for all phases of an electrical system.

6. The switchgear assembly of claim 1,
wherein the flexible openings comprise slit cutouts, and wherein the slit cutouts are aligned with a pathway of the electrical cables.

7. The switchgear assembly of claim 6,
wherein the slit cutouts are designed as star-shaped slit cutouts.

8. The switchgear assembly of claim 1, further comprising:
bus compartment barriers secured to the support post assembly, wherein the bus compartment barriers are arranged adjacent to the insulation barriers.

9. The switchgear assembly of claim 1,
wherein the insulation barrier comprises a plurality of elements including insulation brackets, mounting plates, inner barriers and outer barriers.

10. The switchgear assembly of claim 9,
Wherein the insulation brackets are secured to the support post assembly, and the mounting plates are secured to the insulation brackets, and wherein the insulation brackets and the mounting plates, when installed, create space and distance away from the lugs and lug pads.

11. The switchgear assembly of claim 9,
wherein the mounting plates comprise knockout holes providing a rigid covering for unused cable spots.

12. The switchgear assembly of claim 9,
wherein the inner barriers and outer barriers comprise non-conductive materials and parallel slit cutouts.

13. The switchgear assembly of claim 12,
wherein the parallel slit cutouts fold back on the electrical cables.

14. The switchgear assembly of claim 9,
wherein the inner barriers are mounted to the second mounting plates, and wherein the outer barriers are mounted to the inner barriers.

15. The switchgear assembly of claim 9,
wherein the insulation barrier is configured as single-phase barrier.

16. A method for assembling switchgear, the method comprising:
connecting electrical cables to lugs and lug pads within a cabinet structure of a switchgear device,
installing an insulation barrier after the connecting of the electrical cables such that the insulation barrier covers electrical components including the lugs and lug pads to provide protection,
wherein the insulation barrier comprises one or more flexible openings allowing the electrical cables to pass through the insulation barrier.

17. The method of claim 16,
wherein installation of the insulation barrier comprises passing the electrical cables through the one or more flexible openings and mounting the insulation barrier to a support post assembly of the cabinet structure.

18. The method of claim 16,
wherein installation of the insulation barrier comprises securing insulation brackets to the support post assembly in an essentially horizontally manner, securing mounting plates to the insulation brackets in an essentially vertical manner, wherein the insulation brackets and mounting plates, when installed, create space for distance to the electrical components including the lugs and lug pads.

19. The method of claim 18,
wherein the installation of the insulation barrier further comprises securing inner barriers to the mounting plates and securing outer barriers to the inner barriers.

20. The method of claim 19,
wherein the inner barriers and outer barriers comprise non-conductive material and parallel cutout slits aligned with a pathway of the electrical cables.
